(19) United States
(12) Patent Application Publication
(10) Pub. No.: US 2007/0202857 A1
(43) Pub. Date: Aug. 30, 2007

(54) Vehicle maintenance system

(75) Inventor: Nobuhiro Hara, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/700,887

(22) Filed: Feb. 1, 2007

(30) Foreign Application Priority Data
Feb. 7, 2006 (JP) 2006-029241

(51) Int. Cl. H04Q 7/38; H04Q 7/22; H04M 3/42

(52) U.S. Cl. 455/414.1

(57) ABSTRACT

A vehicle maintenance system comprises: at least one customer's terminal; at least one dealer's terminal; a customer vehicle terminal associated with the customer's terminal; and a maintenance center terminal including a control server, all terminals mutually connected via a communication network to exchange maintenance-related information among the terminals. Accordingly, maintenance-related information including maintenance information, repair shop (dealer) information, and maintenance-reservation management information can be comprehensively unified. Thus, the customer is enabled to make a maintenance reservation without preliminarily getting any dealer information (e.g. regular closing day, location, contact address, how much the service garage is tied up, etc.).

### FIELD OF THE INVENTION

This invention relates to a vehicle maintenance system for use in the maintenance of customers' vehicles.

### BACKGROUND OF THE INVENTION

Conventional vehicle maintenance systems are nothing more than mere records of maintenance made in the past and pieces of information on registered customers, so that, if a customer wants to get further unknown information about the condition of his vehicle, he must contact his dealer and ask about it. Otherwise, he would overlook the information.

Besides, in order to make a reservation for maintenance, he must call up a dealer, and, to do this, he must obtain the dealer's location, contact address, and business hours.

There is disclosed in Japanese Patent Application Laid Open No. 2003-50879 a computer method for obtaining, in a relatively simple manner, information on sophisticated auto repair techniques that are so far limited to specialty shops. This method allows a client to access a database of a server that stores car repair techniques and fixing procedures from his terminal via a communication network and search the database for information on a desired repair technique and a repair procedure using a search means. He can then display the information on the display screen of the terminal and print out the information as needed.

A Japanese Patent Application Laid Open No. 2003-99665 discloses a computer method for obtaining, in a relatively simple manner, information on auto repair techniques of foreign cars that are so far limited to foreign car dealers. This method allows a customer to access a database of a server that stores information on auto repair techniques for foreign cars from his terminal via a communication network, search the database for the information using a search means, display the information on the display screen of the terminal, and download detailed information extracted from the foreign car information indices displayed on the screen.

However, the prior art techniques only provides specialized repair information that it is difficult for a customer to utilize it in practicing the entire repair works in the most efficient way. Moreover, there is a problem that what is done in the work and work procedure depend on the person who does it.

Japanese Patent Application Laid Open No. 2003-132168 discloses an auto repair method in which a customer requests a repair factory only for purely technical matters such as repair and maintenance of his vehicle, and he himself procures parts and materials that are necessary for the repair and maintenance.

Nevertheless, this prior art method cannot be generally practiced, since the customer must have a considerable degree of expert knowledge to procure the parts.

Japanese Patent Application Laid Open No. H11-94709 discloses a method of practicing thorough inspection and infallible maintenance and of securing the safety of a vehicle via a communication system, comprising steps of: preliminarily clarifies the contents of inspection, maintenance, and diagnosis of the vehicle; displaying the results of the inspection, maintenance, and diagnosis on a display screen; informing the results to the driver of the vehicle and a governing body; providing an in-vehicle digital car radio with a display screen and various types of terminals to thereby upgrade said car radio for use as a packet communication system; and inputting advisory records and records of troubles stored in the packet communication system into a computer; and transferring the advisory records and records of the troubles to a governing body via communication means, thereby allowing the driver to confirm the contents of the inspection and maintenance.

Japanese Patent Application Laid Open No. 2002-123881 discloses the following art. When an in-vehicle malfunction diagnostic device informs the driver of a vehicle of malfunction that would disable or could severely hinder the driving capability of the vehicle, the driver promptly transmits on the spot a resultant diagnosis to an appropriate maintenance facility. In order to enable him to decide on a measure against the malfunction, a power train-vehicle control system compares the control data defined for predetermined operating conditions with permissible data defined for normal operating conditions. If the control data are departed from a permission range, an in-vehicle malfunction diagnosis processing program will inform the driver of the diagnosis. Upon studying the diagnostic data carte that shows the history of his vehicle up until the malfunction, the driver selects one of the maintenance facilities included in the malfunction diagnosis processing program, and sends the diagnostic data carte to the selected facility via a mobile data communication terminal.

Japanese Patent Application Laid Open No. 2002-73853 discloses a device for providing a vehicle with appropriate remote-maintenance information that can respond to actual conditions of the vehicle, as described below. In this device, bidirectional communications are established between an information service center, the vehicle, and a service factory to provide the information service center with data identifying the vehicle and data that describe actual conditions of the vehicle. The information service center determines whether a maintenance work is necessary to the vehicle in that situation, and sends the determination to the vehicle if necessary. Upon receipt of a request from the vehicle for a maintenance work, the information service center checks the reservation status of an associated auto-repair shop, transmits a loading reservation to the auto-repair shop, and notifies the vehicle of the loading reservation made.

However, the prior art disclosed in the cited documents are mainly directed to communication systems for receiving information from vehicles, so that they are not fully satisfactory for customers who desire services or efficient maintenance services from the systems.

Thus, the conventional customer's vehicle maintenance heavily depends on individual customer's self-management plan, and no auxiliary system for supporting the self-management plan is available. Although customers' vehicles are provided with an in-vehicle alarming means (e.g. temperature alarming means for example), they lack a system for collectively transmitting relevant maintenance-related diagnostic information (on, for example, travel distance and gasoline mileage) to the customers. Furthermore, since the sequency and/or work qualities of required maintenance works will differ from one maintenance worker to another, a problem exists in that customers cannot confirm that their dealers are able to maintain homogeneity of quality of the maintenance works.

### SUMMARY OF THE INVENTION

Thus, the invention is directed to solve the above problems, and its object is to provide a vehicle maintenance system capable of integrally controlling maintenance-related information that includes, for example, maintenance information, repair shop (or dealer) information, and maintenance reservation management information, thereby allowing a customer to make a maintenance reservation without preliminarily getting any dealer information (e.g. regular closing day, location, contact address of a dealer, and how much the service garage is tied up). It is another object of the invention to provide a vehicle maintenance system that makes maintenance reservation possible twenty-four hours a day, seven days a week. It is a further object of the invention to provide a vehicle maintenance system capable of not only informing a customer of a forgettable regular inspection and periodic maintenance but also allowing him to easily grasp the current and past time-dependent conditions of the vehicle.

To this end, there is provided in accordance with one aspect of the present invention a vehicle maintenance system, comprising: at least one customer's terminal; at least one dealer's terminal; a customer vehicle terminal associated with the customer's terminal; and a maintenance center terminal (hereinafter the maintenance center terminal will be also referred to as center terminal) having a control server, with all terminals mutually connected via a communication network to exchange maintenance-related information among the terminals.

According to the invention, maintenance-related information including maintenance information, repair shop (or dealer) information, and maintenance-reservation management information can be integrally controlled by constructing a communication network among the customer's terminal, dealer's terminal, customer vehicle terminal, and center terminal, thereby enabling the customer to make a maintenance reservation without preliminarily getting information on the dealer (e.g. regular closing day, location, contact address, how much the service garage is tied up, etc.). The invention enables the customer to make a maintenance reservation via the center terminal twenty-four hours a day, seven days a week.

In this case, the customer's terminal and the dealer's terminal each preferably have dedicated communication means connectible to the customer vehicle terminal.

Then, the customer's terminal and the dealer's terminal have an efficient dedicated communication tool connected to the customer vehicle terminal.

The customer's terminal may have means for receiving a resultant diagnosis of the customer's vehicle from the customer vehicle terminal, and is capable of transmitting to the center terminal a request for a maintenance reservation, based on the resultant diagnosis and his preferences.

In this way, the customer's terminal can receive the resultant diagnosis of the customer's vehicle from the customer vehicle terminal and can transmit to the center terminal a request for a maintenance reservation based on the resultant diagnosis and his preferences, so that he can not only be provided with notice and information about a routine inspection and regular maintenance that could be otherwise easily forgotten, but also easily grasp the current and past time-dependent conditions of the vehicle. Moreover, by sending a request for a preferred maintenance reservation to the center terminal, he can also obtain the dealer's location and reservation status, and the names of persons in charge, etc. from the center terminal.

The customer's terminal preferably has means for transferring the information on the dealer's location received from the center terminal to the car navigation system of the customer's vehicle via the customer vehicle terminal.

Then, since the customer's terminal transfers information regarding the preferred dealer's location received from the center terminal to the car navigation system of the customer, the customer can easily enjoy maintenance service not only in his living area but also at his hometown and a place on his journey.

The dealer's terminal preferably has communication means for obtaining a maintenance request from a customer and the maintenance history of the customer's vehicle from the center terminal, and for transmitting maintenance information on the customer's vehicle to the center terminal.

Then, the dealer's terminal can easily obtain the maintenance request for, and the maintenance history of, the customer's vehicle from the center terminal. Further, since the maintenance information on the customer's vehicle is transmitted to the center terminal, unified management of the customer's vehicle can be easily attained.

The dealer's terminal preferably has means for transmitting maintenance criteria for a vehicle of interest to the center terminal to obtain proper maintenance techniques and the most efficient maintenance procedure for that vehicle from the center terminal.

Thus, since the maintenance criteria for that vehicle are transmitted to the center terminal, the dealer's terminal can obtain proper maintenance techniques and the most efficient maintenance procedure for that vehicle from the center terminal.

The customer's terminal may have means for obtaining, from the center terminal, messages notifying items that require regular maintenance.

Thus, the center terminal can send a massage to the customer's terminal to notify the items that require regular maintenance.

The customer's terminal may have mean for performing a self-diagnosis of the customer's vehicle via the customer vehicle terminal in cycles at an arbitrary period or at a time the customer wishes it, and for displaying the resultant self-diagnosis.

In this way, the customer's terminal can perform a self-diagnosis of the customer's vehicle in cycles of an arbitrary period or at a time the customer wishes it, and can display the result on the terminal.

The customer vehicle terminal may have means for automatically providing the customer's terminal with the information regarding an alarming and/or emergent condition that has occurred to the customer's vehicle.

Then, should an alarming and/or emergent condition has occurred to the customer's vehicle, the customer vehicle terminal can automatically inform the customer's terminal of the alarming and/or emergent condition.

When a customer's terminal is a television (TV) receiver having a set top box or a built-in receiver unit that can receive a digital broadcast signal, the terminal is preferably adapted to recommend a nearby repair shop by giving the dealer's location obtained on the basis of the set up information (e.g. postal code number) for the receiver unit.

If the customer's terminal is a mobile communications terminal equipped with a GPS, it can recommend a nearby repair shop by giving the dealer's location based on GPS information.

Irrespective of whether such GPS information is available or not, a nearby repair shop can be spotted and recommend on the basis of manually inputted arbitrary locational information (such as a telephone number, mailing address, postal code, etc. of the dealer).

### BRIEF DESCRIPTION OF THE DRAWINGS

FIG. 1 is a diagram showing an arrangement of a relevant part of a vehicle maintenance system in accordance with one embodiment of the invention.

FIG. 2 is a flowchart showing an exemplary data processing procedure executed by a customer vehicle terminal.

FIG. 3 is a flowchart showing an exemplary data processing procedure executed by a customer's terminal.

FIG. 4 is a flowchart showing an exemplary data processing procedure executed by a management system of a dealer's terminal.

FIG. 5 is a flowchart showing an exemplary data processing procedure executed by a dealer's maintenance terminal.

FIG. 6 illustrates exemplary display screens of a customer's terminal.

FIG. 7 illustrates exemplary display screens of a maintenance terminal.

### DETAILED DESCRIPTION OF THE PREFERRED EMBODIMENT

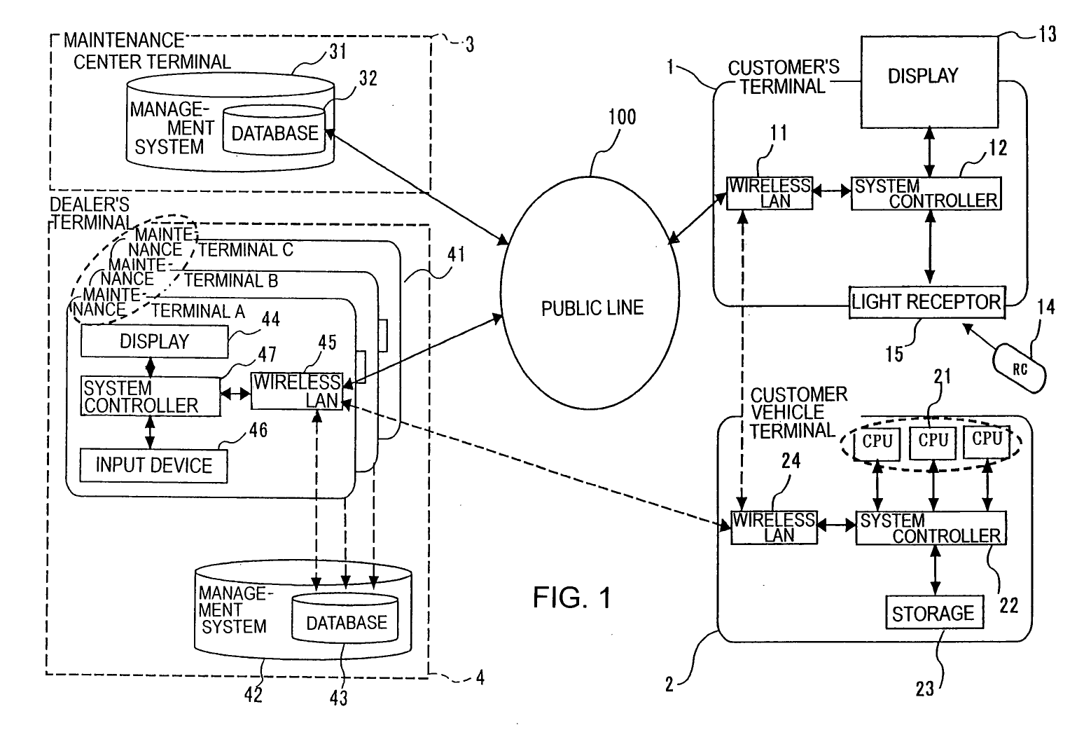

Referring to FIG. 1, there is shown a customer's terminal 1 having a wireless LAN (Local Area Network) 11 connectible to a communication network, a system controller 12, a display 13, a remote controller (RC) 14 serving as an input means, and a light receiving section 15 responsive to the RC 14. In the example shown in FIG. 1, the customer's terminal 1 is implemented as a TV receiver having a built-in diagnostic system. Of course, the customer's terminal 1 can be any type of terminal such as a mobile communication device, a dedicated terminal, and a public terminal, so long as it has such built-in diagnostic system as stated above.

A customer vehicle terminal 2 has, in addition to conventional central processing units (CPUs) 21, a system controller 22 for controlling the CPUs 21 in a unified manner, a storage device 23, and a wireless LAN 24 serving as a dedicated communication tool for establishing communications between the customer's terminal 1 and a dealer's terminal 4 described below. The dedicated communications tool is not limited to the wireless LAN 24. It can be any type of wired or wireless communication tool, such as one that utilizes wired connectors and another that utilizes FM radio wave.

A maintenance center terminal 3 is a control server equipped with communication means for establishing network communications via a public line 100. The maintenance center terminal 3 has a management system 31 for processing reservation requests from customers, responding to the customers, requesting dealers for customer information, and processing requests from the dealers for maintenance information, and a database 32 for storing the above-mentioned requests and information.

A dealer's terminal 4 has an arbitrary number of maintenance terminals 41, a management system 42 for obtaining information from the maintenance center terminal 3 and managing the information obtained, and a database 43 accumulating the information thus obtained. Each of the maintenance terminals 41 includes such components as: a display 44 for displaying information to a maintenance personnel; a wireless LAN 45 that can communicate with the public line 100, a management system 42, and a customer vehicle terminal 2; an input device 46 for the maintenance personnel to input information; and a system controller 47 for managing these components 44-46.

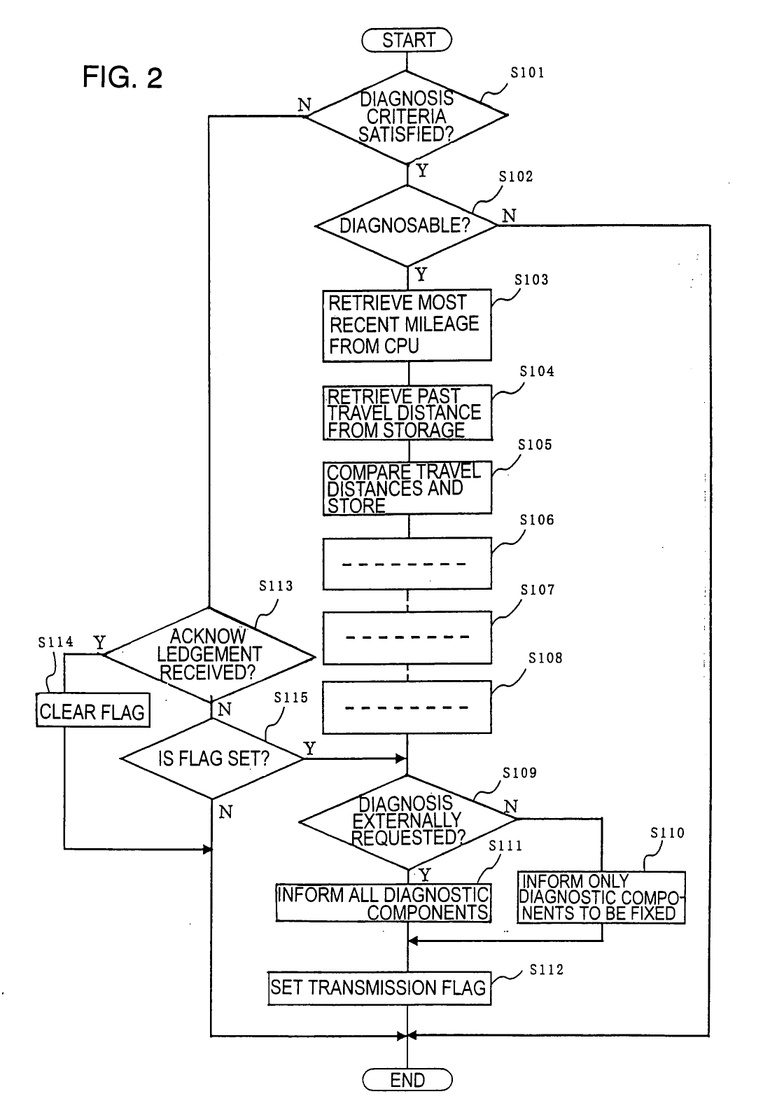

Referring to the flowcharts shown in FIGS. 2-5, operation of the vehicle maintenance system embodying the invention will now be described. A data processing procedure shown in FIG. 2 is executed by the customer vehicle terminal 2, which starts with Step S101 where a query is made as to which of the following diagnosis criteria is satisfied: a predetermined periodic diagnosis is required, or a request for a diagnosis is an external one (i.e. a request not from the customer vehicle terminal 2). When it is judged that a diagnosis is necessary in step S101, a confirmation is made as to whether the vehicle of interest is in a diagnosable condition (Step S102). By “diagnosable condition” it is meant that the vehicle is being parked.

If the vehicle is in the diagnosable condition, then the travel distance is checked, for example. To do this, the current mileage is retrieved from a relevant CPU 21 (Step S103). The distance traveled since the time specified by the customer or since the last oil change is retrieved from the storage 23 (Step S104), from which the system controller 22 calculates gasoline mileage and judges if engine oil change is necessary (Step S105). Steps S103-S105 concern a diagnosis of any one diagnostic item. If multiple diagnostic items are involved, a similar diagnosis will be repeated to each of the items in Steps S106-S108.

In Step S109, a determination is made as to which of the diagnosis criterion that a predetermined periodic diagnosis is required or the criterion that a request for a diagnosis is an external one is satisfied in Step S101. If the diagnosis has been done on the basis of the periodic diagnosis requirement (NO in Step S109), only those items that need maintenance works (e.g. oil change due to over-mileage exceeding a given oil-change limit) will be notified (Step S110). On the other hand, if the diagnosis is based on an external request, all the contents of the diagnosis are notified via the wireless LAN 24 (Step S111). Then, a transmission flag is set up (Step S112) after the resultant diagnosis is sent, and the procedure is ended. Under the condition where diagnosis criteria are not satisfied at the start of the procedure of FIG. 2 (NO in Step S101), if an acknowledgement is received (YES in Step S113) from the counter terminal, the transmission flag is cleared and then the procedure is ended (Steps S101, S113, and S114), but if no acknowledgement is received (NO in Step S113), the resultant diagnosis will be continually sent until an acknowledgement is received, provided that a flag has been set (YES in Step S115) via a loop that goes through Steps S113, S115, and S109.

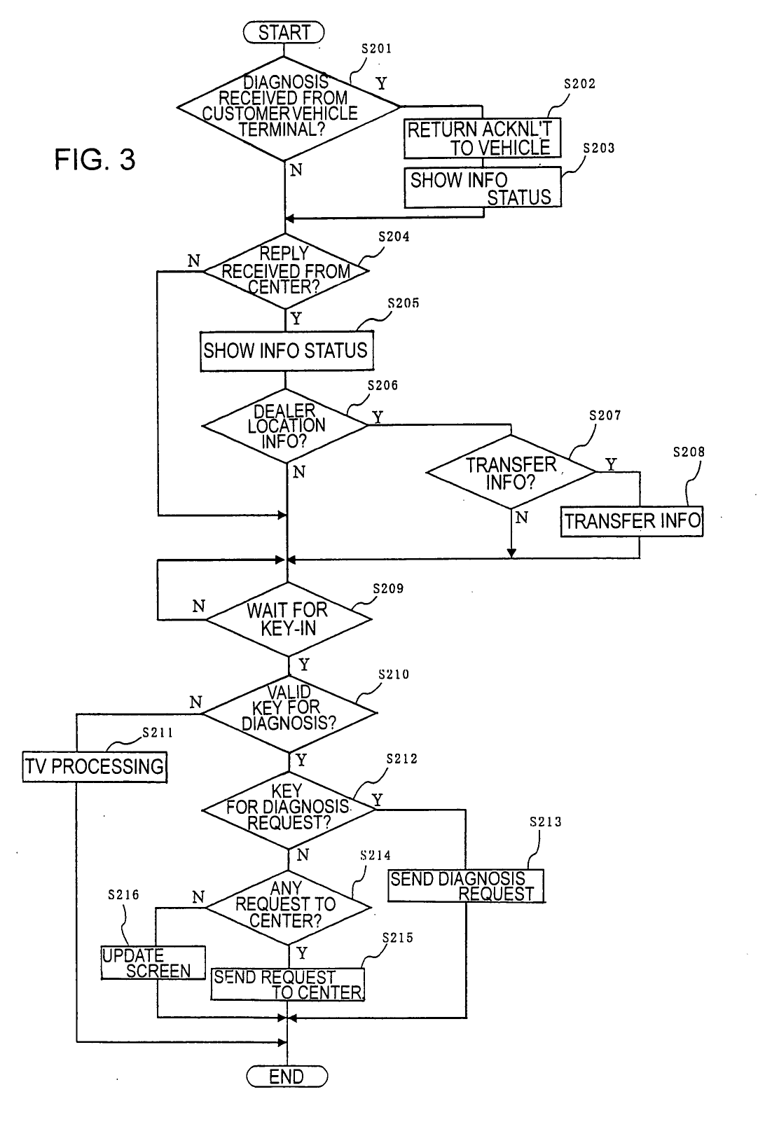

FIG. 3 is a flowchart showing an exemplary data processing procedure executed by the customer's terminal 1. In this embodiment, the customer's terminal 1 is assumed to be a TV set, which is the most familiar terminal for customers. In addition to ordinary functions of a TV set, this TV set has an additional function for processing data, as described below.

The customer's terminal checks in Step S201 if a diagnosis (sent in Steps S110-S111 of FIG. 2) has been received from the customer vehicle terminal 2. If it has (YES in Steps S201), then an acknowledgement is returned to the customer vehicle terminal 2 (Step S202), and the results of the diagnosis is displayed on the display 13 of the customer's terminal 1 (Step S203).

Next, it is checked if any message is received from the maintenance center terminal 3 (Steps S204). If the answer is YES in Step S204, the content of the message is displayed on the display 13 of the customer's terminal 1 (Step S205). In this case, if the information sent from the maintenance center terminal 3 includes the addresses of dealers that can provide a necessary maintenance work (YES in Step S206), then the customer can transfer by choice the information to his car navigation system via the customer vehicle terminal 2 (Steps S207 and S208).

The TV set then waits for key input from the customer (via the TV remote controller for example)(Step S209). If there is any key input (YES in Steps S209), a judgment is made as to whether it is a valid key input for the diagnostic system (Step S210). When it is not valid (NO in Step S210), it is regarded as an ordinary input operation for the TV set, and the procedure moves to the ordinary TV processing (Step S211). On the other hand, when it is a valid key input (YES in Step S210), then a further judgment is made as to whether the key input is to transmit a request for a diagnosis of the vehicle (Step S212).

If it is (YES in Step S212), the request is sent to the customer vehicle terminal 2 (Step S213). Otherwise (NO in Step S212), a further judgment is made as to whether the key input is a request addressed to the maintenance center terminal 3 (Step S214). If it is (YES in Step S214), the request will be transmitted to the maintenance center terminal 3 (Step S215). Otherwise (NO in Step S214), the screen of the display 13 is updated (Step S216). In making a maintenance reservation, the customer can choose a preferred location for the maintenance work (i.e. dealer's location) through communication with the maintenance center terminal 3. Thus, the customer can make a maintenance reservation at a dealer located outside his living area. In this case, the information on the dealer's location can be transferred to his car navigation system by following Steps S206-S208.

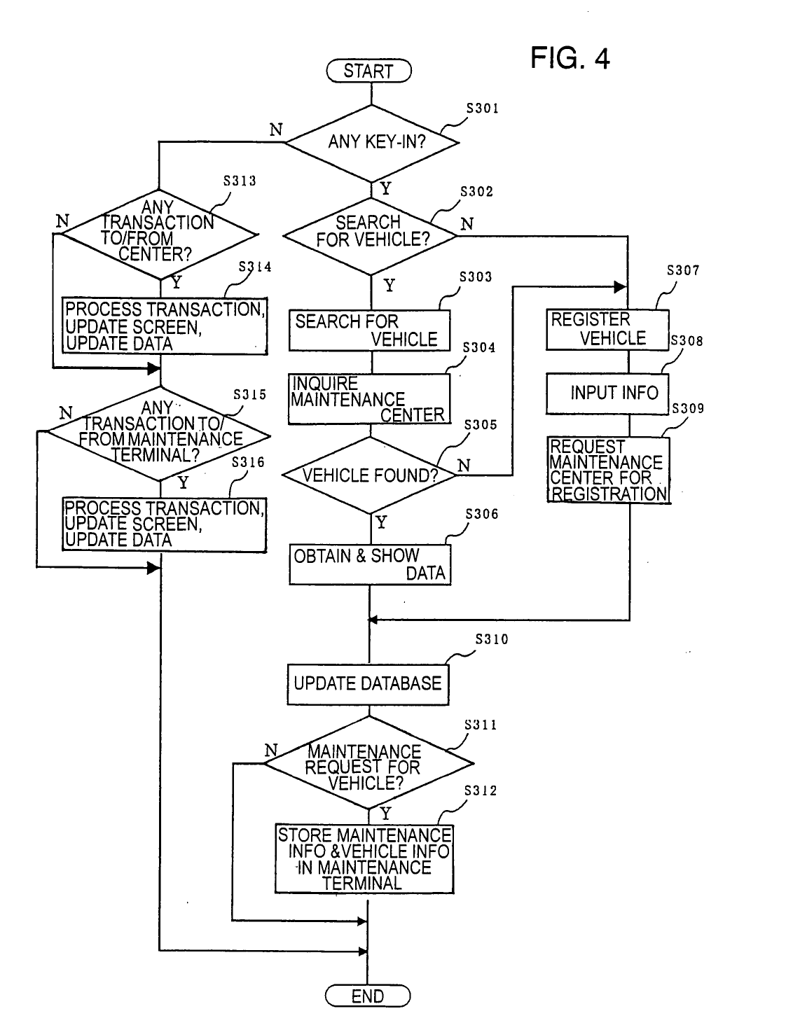

When the data processing procedure shown in FIG. 4 is started in the management system 42 of a dealer's terminal 4, a query is first made as to whether any key is pressed within a certain period of time (Step S301). If the answer is YES in Step S301, then a further query is made as to what function, or mode of data processing, is assigned to the key (Step S302). In this example, two functions are provided, one for the search of customer's vehicle (referred to as vehicle search function) and another for new registration of a customer's vehicle (referred to as vehicle registration function).

When the vehicle search function is chosen (YES in Step S302), a search screen is displayed, and based on the arbitrary retrieval information inputted by the customer, a request is made to the maintenance center terminal 3 to search for the customer's vehicle (Steps S303 and S304). In response to a reply from the maintenance center terminal 3, informing that the vehicle of interest is not registered in the database 32 (NO in Step S305), the procedure moves to the new registration mode (Step S307). When the vehicle has been already registered in the database 32 (YES in Step S305), the procedure proceeds to obtain relevant data from the maintenance center terminal 3 and displays the data (Step S306).

If the key pressed in Step S301 designates a new registration of a customer' vehicle (NO in Step S302), a registration screen is displayed (Step S307). After relevant information for the registration is inputted (Step S308), a request for the registration is transmitted to the maintenance center terminal 3 (Step S309).

In the subsequent steps, as in the vehicle search mode, the database is updated (Step S310); a query is made if a request for maintenance has been made for that vehicle, and, if the answer is YES in Step S311, maintenance information and information on the vehicle are transmitted to one of the maintenance terminals 41 having an unoccupied storage space (Step S312).

If no valid key is pressed in Step S301 (NO in Step S301), the maintenance system 42 checks in Step S313 whether there is any awaiting transaction between the maintenance system 42 and the maintenance center terminal 3, and, if any (YES in Step S313), processes the transaction, updates the screen, and registers unregistered data in the database, as needed (Step S314).

The maintenance system 42 further checks whether there is any awaiting transaction between the maintenance system 42 and the maintenance terminal 41 (Step S315), and, if any (YES in Step S315), processes the transaction, updates the screen, and registers unregistered data in the database, as needed (Step S316). In Step S313, the maintenance terminal 41 can also make a request to, and/or respond to, the maintenance center terminal 3 via the management system 42, according to the content of the message received in the transaction.

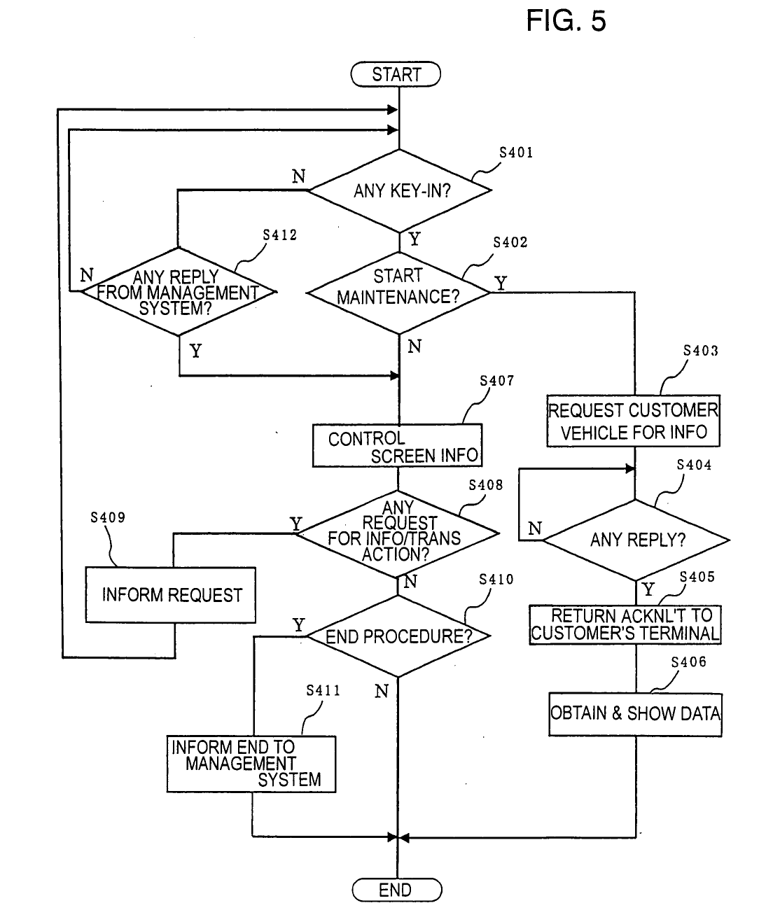

When the data processing procedure shown in FIG. 5 is started in the maintenance terminal 41 of the dealer's terminal 4, a query is first made as to whether any key is pressed within a certain period of time (Step S401). If the answer is YES, then a determination is made as to what function (or mode of processing) is assigned to the key, and an appropriate processing association with the key is executed (Step S402). If a maintenance procedure is started by the key pressed (YES in S402), a request is sent to the customer's terminal 1 (Step S403) for verification of the vehicle and for relevant information on the vehicle. Then the maintenance terminal 41 waits for a reply (via a loop that goes through Steps S403 and S404). Upon detection of a reply for the request (YES in Step S404), the maintenance terminal 41 issues an acknowledgement to the customer' vehicle 1(Step S405), and displays the information obtained on the display 44 (Step S406).

On the other hand, if the key input made in Step S401 has nothing to do with the initiation of a maintenance work (NO in Step S402), the display screen may be controllably changed by manipulating the controller (Step S407). In Step S408, it is checked if any request has arisen to obtain some information or to transmit some information during the manipulation. If so (YES in Step S408), the request is sent to the management system 42 (Step S409). When no such request has been made (NO in Step S408) and the operator of the maintenance terminal 41 signals the end of the procedure (YES in Steps S410), the management system 42 is informed that the maintenance terminal 41 is now not in use (Step S411).

In the event that no valid key input was made in Step S401, awaiting transactions between the maintenance terminal 41 and the management system 42 are checked. If any reply has been received from the management system 42 (YES in Step S412), the procedure proceeds to Step S407 to process the reply.

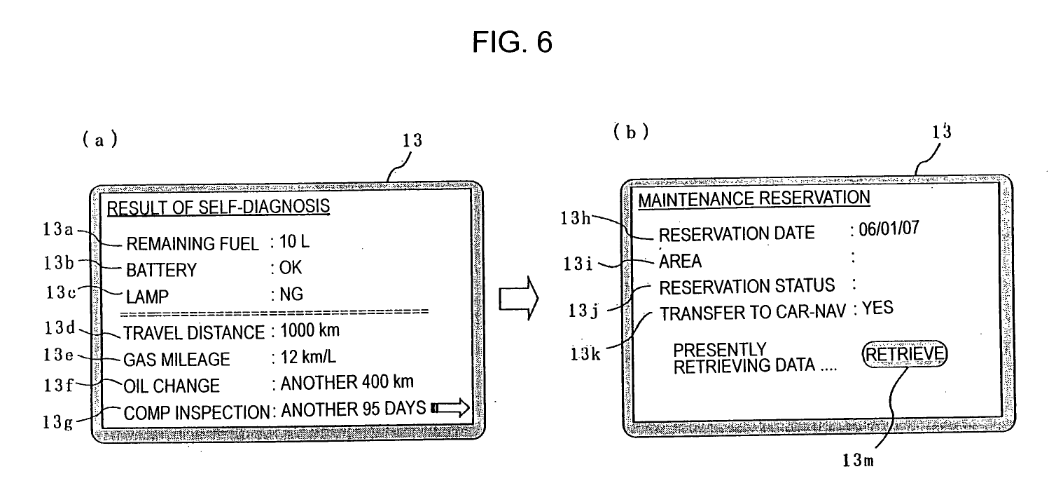

FIGS. 6(a) and (b) illustrate exemplary display screens of the display 13 of the customer's terminal 1. The customer's terminal 1 obtains the status of the customer's vehicle from, for example, a warning received from the customer vehicle terminal 2 or obtained through communications with the customer vehicle terminal 2 under the control of the customer.

The information then accessible to the customer includes self-diagnostic information that can be detected by the system controller 22 mounted on the customer vehicle terminal 2 and informative notices generated by arbitrary triggers. Here, self-diagnostic information means information on such checkup items as residual fuel quantity, battery voltage, lamp failure, oil pressure, and so on, that would directly affect the driving of the vehicle. Informative notices include information on such items as travel distance, gasoline mileage, time of oil change, the date of next compulsory automobile inspection, and the date of license renewal.

In the example shown in FIG. 6(a), there is shown diagnostic information regarding residual fuel quantity 13a, results of battery check 13b and lamp check 13c, and informative notices regarding the mileage 13d, gasoline mileage 13e, date of oil change 13f, and remaining days for the next compulsory automobile inspection. If the customer thinks then that the car needs a maintenance work, he proceeds to the next screen as shown in FIG. 6 (b) and inputs such information (conditions) as: preferred date of maintenance work 13h; preferred location 13i in the event that the maintenance work is made outside his living area; maintenance reservation status 13j at dealers; a choice 13k as to if he wishes the transfer of the dealer's location to his car navigation system when the maintenance reservation is booked. He then presses a search key 13m to perform a search for a dealer satisfying the inputted conditions. FIG. 6 (b) shows a retrieval screen in search operation.

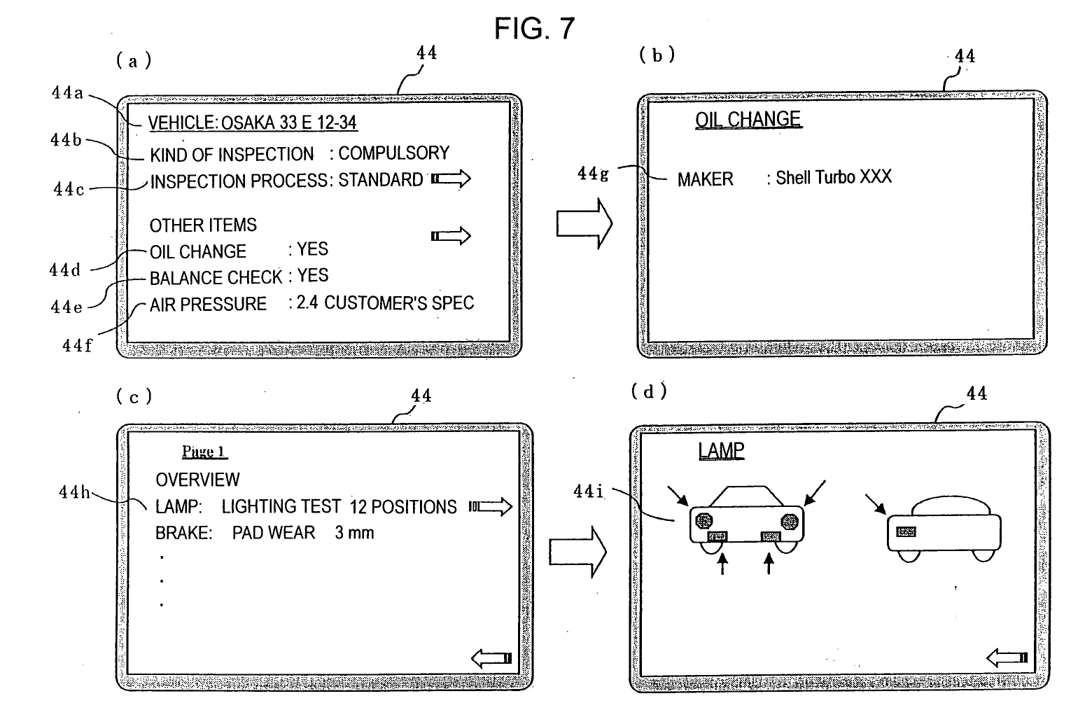

FIG. 7 (a) illustrates the main screen of the display 44 of the maintenance terminal 41, showing the information on a registered vehicle transmitted in Step S312 of FIG. 4. The main screen clearly shows, for example, what maintenance works (44b and 44c) must be given to the customer's vehicle of interest (44a), and if there is any customer's preference in the maintenance (44d-44f). In the example shown herein, it is seen that the customer wishes it; oil change (44d), checkup of tire balances (44e); and adjustment of tire pressure to a specified value (44f). In the case where further detailed information is available, the customer can proceed to the next screen as shown FIG. 7(b) to obtain the information. It is seen in this figure that the manufacture of the oil (44g) is specified by the customer.

Referring next to FIG. 7(c), there is shown the most efficient procedure for maintenance that involves multiple maintenance works, as in the routine checkup or in a compulsory vehicle inspection. It is seen in FIG. 7(c) that “lamp” (44h) is shown on the screen to be a checkup item. The screen clearly indicates the number of lamps to be checked and what should be checked on the lamps. The locations of lamps to be checked depend not only on the type of a vehicle but also customer's option. The screen of FIG. 7(d) clearly shows the arrangement of the lamps 44i to be checked, which helps prevent the inspection worker from overlooking inspection of lamps or from lowering the inspection quality.

In this way, by allowing the customer to always grasp the conditions of his vehicle, he can avoid missing the right time of maintenance and always maintain the vehicle in good condition.

Furthermore, since the inventive vehicle maintenance system is equipped with communication means, information can be shared between the customer and dealers, so that it is possible to obtain from the database a maintenance procedure that fits the customer's vehicle and appropriate tips for dealing with problems anticipated in the maintenance on the basis of the current vehicle condition. By clearly notifying the maintenance procedure and the current vehicle condition to the maintenance terminal 41, maintenance skill of a dealer can be maintained at a constant level.

As described above, maintenance-related information including maintenance information, repair shop (dealer) information, and maintenance-reservation management information can be integrally controlled by constructing a communication network linking the customers' terminals 1, dealers' terminals 4, customer vehicle terminal 2, and a center terminal 3 in accordance with this embodiment, thereby enabling the customer to make a maintenance reservation without preliminarily getting any dealer information (e.g. regular closing day, location, contact address, how much his service garage is tied up, etc.). Furthermore, such reservation can be made via the maintenance center terminal, twenty-four hours a day, seven days a week.

In addition, the terminals 1 and 4 can efficiently communicate with the customer vehicle terminal 2 (wireless LAN 24) via the respective wireless LANs 11 and 45 each serving as the dedicated means for communication with the customer vehicle terminal 2, as described above.

It should be appreciated that, since the customer's terminal 1 can receive the result of the diagnosis of the customer's vehicle from the customer vehicle terminal 2 and can transmit to the center terminal 3 a request for a maintenance reservation based on the diagnosis and his preferences, he can easily get not only notices and information about forgettable routine inspections and regular maintenance, but also current and past time-dependent conditions of the vehicle. Furthermore, by sending a request for a preferred maintenance reservation to the center terminal 3, he can also obtain the locations of dealers available to him, their reservation status, and the names of persons in charge, etc. from a reply transmitted to him.

Since the customer's terminal 1 can transfer the information regarding a preferred dealer's location received from the center terminal 3 to the customer's car navigation system, the customer can easily enjoy maintenance service not only in his living area but also at his hometown and a place on his journey.

If the customer's terminal 1 has a set top box or a TV receiver having a built-in digital unit capable of receiving a digital broadcast signal, the customer's terminal 1 can obtain the location of a recommended nearby repair shop on the basis of the set up information of the digital unit (e.g. postal code number).

If the customer's terminal 1 is a mobile communications terminal equipped with a GPS (Global Positioning System), it can recommend a nearby repair shop on the basis of GPS information.

Irrespective of whether such GPS information is available or not, a nearby repair shop can be spotted and recommended to the customer if he manually inputs arbitrary locational information (such as a telephone number, mailing address, postal code, etc. of the repair shop).

On the other hand, the dealer's terminal 4 can easily obtain the maintenance request from a customer and the maintenance history of the customer's vehicle from the center terminal 3. Further, by transmitting the maintenance information on the customer's vehicle to the center terminal 3, unified management of the customer's vehicle can be easily attained.

In addition, by transmitting the maintenance criteria for a vehicle of interest to the center terminal 3, the dealer's terminal 4 can obtain proper maintenance techniques and the most efficient maintenance procedure for that vehicle from the center terminal 3.

The center terminal 3 can send a massage to the customer's terminal 1 to notify the customer of the items that require regular maintenance.

The customer's terminal 1 can perform a self-diagnosis of his vehicle in cycles of an arbitrary period or at a time the customer wishes it, and can display the result on the display of the terminal.

Should an alarming and/or emergent condition has occurred to the customer's vehicle, the customer vehicle terminal 2 can automatically provide information regarding the alarming and/or an emergent condition to the customer's terminal 1.

1. A vehicle maintenance system, comprising: at least one customer's terminal; at least one dealer's terminal; a customer vehicle terminal associated with said customer's terminal; and a center terminal having a control server, all terminals mutually connected via a communication network to exchange maintenance-related information among said terminals.

2. The vehicle maintenance system according to claim 1, wherein each of said customer's terminal and dealer's terminal has dedicated communication means connectible to said customer vehicle terminal.

3. The vehicle maintenance system according to claim 1, wherein said customer's terminal has means for receiving a resultant diagnosis of the customer's vehicle from said customer vehicle terminal, and is capable of transmitting to said center terminal a request for a maintenance reservation, based on the resultant diagnosis and his preferences.

4. The vehicle maintenance system according to claim 1, wherein said customer's terminal has means for transferring the information on the dealer's location received from said center terminal to the car navigation system of the customer's vehicle via said customer vehicle terminal.

5. The vehicle maintenance system according to claim 1, wherein said dealer's terminal has communication means for obtaining a maintenance request from a customer and the maintenance history of said customer's vehicle to transmit the maintenance information on said customer's vehicle to said center terminal.

6. The vehicle maintenance system according to claim 1, wherein said dealer's terminal has means for transmitting maintenance criteria for a vehicle of interest to said center terminal to obtain proper maintenance techniques and the most efficient maintenance procedure for that vehicle from said center terminal.

7. The vehicle maintenance system according to claim 1, wherein said customer's terminal has means for obtaining from said center terminal a message notifying the items that require regular maintenance.

8. The vehicle maintenance system according to claim 1, wherein said customer's terminal has mean for performing a self-diagnosis of the customer's vehicle via said customer vehicle terminal in cycles at an arbitrary period, or performing a self-diagnosis at a time the customer wishes it, and for displaying the resultant self-diagnosis.

9. The vehicle maintenance system according to claim 1, wherein said customer vehicle terminal has means for automatically providing said customer's terminal with the information regarding an alarming and/or emergent condition that has occurred to said customer's vehicle.

10. The vehicle maintenance system according to claim 2, wherein said customer's terminal has means for receiving a resultant diagnosis of the customer's vehicle from said customer vehicle terminal, and is capable of transmitting to said center terminal a request for a maintenance reservation, based on the resultant diagnosis and his preferences.

11. The vehicle maintenance system according to claim 3, wherein said customer's terminal has means for transferring the information on the dealer's location received from said center terminal to the car navigation system of the customer's vehicle via said customer vehicle terminal.

12. The vehicle maintenance system according to claim 4, wherein said dealer's terminal has communication means for obtaining a maintenance request of a customer and the maintenance history of said customer's vehicle to transmit the maintenance information on said customer's vehicle to said center terminal.

13. The vehicle maintenance system according to claim 4, wherein said customer's terminal is a mobile communications terminal equipped with a GPS and is adapted to provide as said dealer's location the location of a recommended nearby repair shop obtained on the basis of GPS information.

14. The vehicle maintenance system according to claim 4, wherein said customer's terminal is a television receiver having either one of a set top box and a built-in receiver unit capable of receiving a digital broadcasting signal, and is adapted to provide as said dealer's location the location of a recommended nearby repair shop obtained on the basis of the set up information for said receiver unit.

15. The vehicle maintenance system according to claim 5, wherein said dealer's terminal has means for transmitting maintenance criteria for a vehicle of interest to said center terminal to obtain proper maintenance techniques and the most efficient maintenance procedure for that vehicle from said center terminal.

16. The vehicle maintenance system according to claim 6, wherein said customer's terminal has means for obtaining from said center terminal a massage notifying maintenance items that require regular maintenance.

17. The vehicle maintenance system according to claim 7, wherein said customer's terminal 1 has mean for performing a self-diagnosis of the customer's vehicle via said customer vehicle terminal in cycles at an arbitrary period, or performing a self-diagnosis at a time the customer wishes it, and for displaying the resultant self-diagnosis.

18. The vehicle maintenance system according to claim 8, wherein said customer vehicle terminal has means for automatically providing said customer's terminal with the information regarding an alarming and/or emergent condition that has occurred to said customer's vehicle.

19. The vehicle maintenance system according to claim 13, adapted to recommend a nearby repair shop based on manually inputted arbitrary locational information, irrespective of said GPS information.

20. The vehicle maintenance system according to claim 14, adapted to recommend, irrespectively of said GPS information, a nearby repair shop based on manually inputted arbitrary locational information.
